(19) United States
(12) Patent Application Publication
(10) Pub. No.: US 2026/0262262 A1
(43) Pub. Date: Sep. 3, 2026

(54) METHOD FOR ALLEVIATING LEAKAGE DEGRADATION EFFECT IN GaN DEVICE

(71) Applicants: YANGZHOU UNIVERSITY, Jiangsu (CN); Beijing Satellite Factory Co., Ltd., Beijing (CN); PEKING UNIVERSITY, Beijing (CN)

(72) Inventors: Yuxiong XUE, Jiangsu (CN); Rongxing CAO, Jiangsu (CN); Dongping YANG, Jiangsu (CN); Weixiang ZHOU, Jiangsu (CN); Hanxun LIU, Jiangsu (CN); Xuelin YANG, Jiangsu (CN); Chengan WAN, Jiangsu (CN); Mi LIU, Jiangsu (CN); Bo SHEN, Jiangsu (CN)

(73) Assignees: YANGZHOU UNIVERSITY, Jiangsu (CN); Beijing Satellite Factory Co., Ltd., Beijing (CN); PEKING UNIVERSITY, Beijing (CN)

(21) Appl. No.: 19/212,624

(22) Filed: May 19, 2025

(30) Foreign Application Priority Data
Feb. 28, 2025 (CN) 202510231670.2

(51) Int. Cl. H10D 62/10; G01R 31/26; G06F 30/367; G06F 30/373; G06F 30/398; G06F 117/12; G06F 119/02; H10D 62/85

(52) U.S. Cl. CPC H10D 62/102; G01R 31/2642; G06F 30/367; G06F 30/373; G06F 30/398; H10D 62/8503; G06F 2117/12; G06F 2119/02

(57) ABSTRACT

The present disclosure discloses a method for alleviating a leakage degradation effect of a GaN device. The method determines appropriate neutron irradiation conditions through simulation methods, which can ensure the introduction of sufficient effective traps into GaN devices and maintain the performance degradation of GaN devices within an acceptable range; this method utilizes simulation methods to accurately predict the degradation trend under different irradiation conditions, which not only reduces experimental costs but also provides scientific basis for experiments; After determining the appropriate neutron irradiation conditions, this method conducts neutron irradiation test to improve the anti leakage degradation performance of GaN devices; the method verifies through the experimental verification of leakage degradation that GaN devices treated with neutron pre-irradiation can still maintain a low leakage current level under high LET heavy ion radiation conditions, and the growth rate of leakage is significantly reduced compared to devices without neutron irradiation.

### CROSS-REFERENCE TO RELATED APPLICATIONS

This application claims the priority benefit of China application serial no. 202510231670.2, filed on Feb. 28, 2025. The entirety of the above-mentioned patent application is hereby incorporated by reference herein and made a part of this specification.

### TECHNICAL FIELD

The present disclosure relates to the technical field of power semiconductor devices, particularly to a method for alleviating a leakage degradation effect in a GaN device.

### DESCRIPTION OF RELATED ART

As a third-generation wide bandgap semiconductor material, gallium nitride (GaN) has become a key material in modern electronic technology due to its excellent electrical properties such as high saturation electron mobility, high breakdown voltage, wide bandgap characteristics, and outstanding high-frequency and high-power characteristics; and is expected to be widely used in various application fields such as aerospace, satellite communication, and power systems. However, unlike ground environments, GaN devices face various radiation effects in space environments, which can lead to performance degradation or even damage of the devices.

Among numerous radiation effects, leakage degradation effect is a newly discovered radiation damage mode in recent years. Unlike traditional radiation effects such as displacement damage effect and total fluence effect, leakage degradation effect is currently merely observed in wide bandgap semiconductor devices (such as SiC and GaN devices), which limits the application of wide bandgap devices in radiation environments. The leakage degradation effect refers to the phenomenon where high-energy particle irradiation forms a leakage channel inside a GaN device when the leakage source voltage V_{DS} of the device increases to one certain value, resulting in a continuous increase in leakage current and the GaN device entering the leakage degradation zone. This not only affects the working efficiency of GaN devices, but may also cause energy loss and thermal accumulation at high frequencies and high powers, thereby reducing the overall performance of the system. For example, an increase in leakage current not only leads to a decrease in switching efficiency, but also prolongs the response time of GaN devices, increases switching losses, and reduces energy efficiency especially in high-frequency applications. Due to limitations in thermal management capabilities, an increase in leakage current can generate excessive heat in GaN devices, which may further lead to thermal runaway phenomenon and even burn out GaN devices, seriously affecting their long-term reliability. As radiation damage accumulates, the breakdown voltage of GaN devices may decrease, making them be more prone to breakdown when subjected to higher voltages, further threatening the safety of GaN devices and systems. It can be seen that the leakage degradation effect caused by radiation poses a huge threat to the normal operation and reliability of GaN devices, especially when applied in severe radiation environments such as aerospace and nuclear energy, which may lead to catastrophic consequences. Therefore, how to effectively alleviate the leakage degradation caused by radiation has become an urgent problem to be solved in the field of radiation resistance.

### SUMMARY

Technical problems to be solved: in response to the technical problem of GaN devices operating in high radiation environments in the background technology, the present disclosure provides a method for alleviating a leakage degradation effect of a GaN device. The aim is to optimize the anti leakage degradation performance of GaN devices by introducing appropriate traps inside the GaN devices through the neutron irradiation on the GaN devices; The method can significantly improve the stability and reliability of the GaN devices in the high radiation environments, ensuring the long-term reliable usage in aerospace and other critical fields.

Technical solutions: Provided in the present disclosure is a method for alleviating a leakage degradation effect in a GaN device. The method includes the following steps.

In Step 1, a type of a GaN device that is required to be optimized for an anti leakage degradation performance is selected, and based on structural parameters for the selected GaN device, a two-dimensional structural model of the GaN device is established in a TCAD.

In Step 2, a physical model and a calculation method are selected, electrical characteristics of the GaN device is obtained, and then the electrical characteristics of the GaN device are optimized to be consistent with the standard values in the GaN device manual by adjusting a doping concentration and structural size parameters for the GaN device.

In Step 3, a neutron irradiation simulation is performed on the optimized GaN device, and trap information generated inside the GaN device during the neutron irradiation is calculated by adding a displacement damage related model.

In Step 4, a neutron irradiation fluence is varied, electrical characteristic curves under different irradiation fluences are obtained, and a most sensitive electrical parameter is selected as a standard for evaluating a performance degradation of the GaN device after the neutron irradiation.

In Step 5, variations in sensitive parameters are compared under the different irradiation fluences are compared, and a minimum neutron irradiation fluence F_{MIN} and a maximum neutron irradiation fluence F_{MAX} corresponding to degradation values for the sensitive parameters are determined.

In Step 6, a qualified GaN device sample are selected for an electrical parameter testing, and a neutron irradiation test is conducted on the GaN device; the neutron irradiation fluence is selected as one certain value between F_{MIN} and F_{MAX.}

In Step 7, the neutron irradiation is terminated when the neutron irradiation fluence reaches a preset fluence, and the anti leakage degradation performance of the GaN device is optimized.

Preferably, in Step 3, a range of a neutron irradiation energy E for alleviating the leakage degradation in the GaN device is between 1 mega electron volt (MeV) and 10 MeV.

Preferably, in Step 5, the minimum neutron irradiation fluence F_{MIN} corresponds to a 10% degradation value for the sensitive parameters, and the maximum neutron irradiation fluence F_{MAX} corresponds to a 20% degradation value for the sensitive parameters.

Preferably, after a residual neutron irradiation fluence reaches a safe value, an electrical performance measurement is performed on the optimized GaN device in Step 7, degradation values for the electrical characteristics before and after the neutron irradiation are compared to determine whether the degradation values satisfy derating requirements, and the data are saved.

Preferably, an irradiation experiment is conducted on the GaN device treated with t neutron irradiation, verifying whether the anti leakage degradation performance of the GaN device is improved is verified.

In comparison with the prior art, the present disclosure at least has the following beneficial effects.

1. The present disclosure innovatively proposes a method for alleviating a leakage degradation effect in a GaN device, which not only avoids the modifications to the layout design and processing technique of the GaN device, but also does not require additional anti irradiation circuits. Only by determining the suitable neutron irradiation conditions and conducting the neutron pre-irradiation on the GaN device, the anti leakage degradation performance of the GaN device can be improved.

2. The method combines a simulation and an experimentation, which systematically determines the neutron irradiation conditions suitable for optimizing the anti leakage degradation performance; the method is easy to operate, highly reliable, and effectively reduces the experimental costs through simulation, which not only improves the research and development efficiency, but also ensures the accuracy and reproducibility of experimental results, with good economic and technical advantages.

3. The method pretreats the GaN device through irradiation, which can optimize the anti leakage degradation performance of a large number of GaN devices simultaneously, without limiting the types of GaN devices, and has good convenience and universality.

4. After a neutron irradiation treatment, the electrical performance of the GaN device in present disclosure deteriorates by no more than 20%, satisfying the maximum derating requirement in industry standards, however, the anti leakage degradation ability of the GaN device is significantly improved. Even under a high LET heavy-ion irradiation, the increase in leakage current is significantly reduced, fully demonstrating the superiority and effectiveness of this technology.

### BRIEF DESCRIPTION OF THE DRAWINGS

FIG. 1 illustrates a schematic diagram of an optimization process for alleviating a leakage degradation effect of a GaN device according to the present disclosure.

FIG. 2 illustrates a schematic diagram of a structure of a p-GaN gate HEMT device ((a a GaN device cell structure; (b) a TCAD simulation two-dimensional structure of the GaN device).

FIG. 3 illustrates an optimized electrical characteristic curve of the GaN device model ((a) a transfer characteristic curve of the GaN device; (b) a breakdown characteristic curve of the GaN device).

FIG. 4 illustrates a diagram of a variation relationship between I_{DS} and V_{TH} with an irradiation fluence after a 2.5 MeV neutron irradiation.

FIG. 5 illustrates a comparison of electrical characteristic curves of the GaN device before and after the 2.5 MeV neutron irradiation with a fluence of 1.8×10¹⁰ n/cm² ((a) transfer characteristic curves before and after the neutron irradiation; (b) output characteristic curves before and after the neutron irradiation).

FIG. 6 illustrates raw data of the leakage degradation of the GaN device before and after the neutron irradiation ((a) I_{D} raw data of the GaN device before the neutron irradiation; (b) I_{D} raw data of the GaN device after the neutron irradiation).

FIG. 7 illustrates variation curves of leakage rate with V_{DS} for the GaN device after the neutron irradiation and non-irradiated GaN device ((a) I_{D} linear fitting; (b) comparison of leakage rate.

### DESCRIPTION OF THE EMBODIMENTS

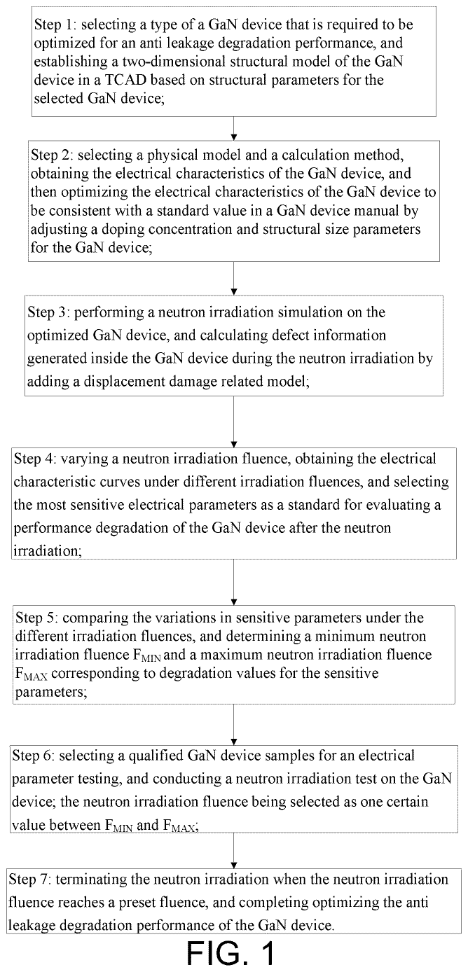

In order to clarify the objectives, technical solutions, and advantages of the embodiments of the present disclosure, the technical solutions of the embodiments of the present disclosure will be described clearly and completely with reference to FIGS. 1 to 7. Obviously, the described embodiments are not all embodiments of the present disclosure, but are one part of the embodiments of the present disclosure. Based on the described embodiments of the present disclosure, all other embodiments obtained by those skilled in the art are within the protection scope of the present disclosure.

As illustrated in FIG. 1, the present disclosure discloses a method for alleviating the leakage degradation effect of GaN devices, which includes the following steps.

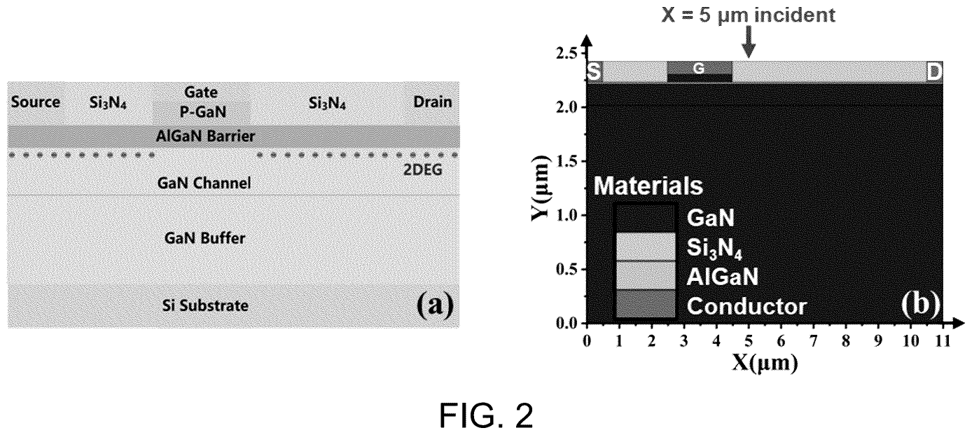

(1) The type of GaN device that is required to be optimized for anti leakage degradation performance is selected, such as using a p-GaN gate HEMT device independently developed by one certain research institute, which is packaged in a TO-254 form, with a threshold voltage V_{TH} of 1.8 V and a rated voltage V_{DSS} of 650 V. The cell structure of the GaN device is as illustrated in (a) of FIG. 2. Based on the structural parameters for the selected GaN device, a two-dimensional structural model of the GaN device is established in TCAD, whose structure is as illustrated in (b) of FIG. 2.

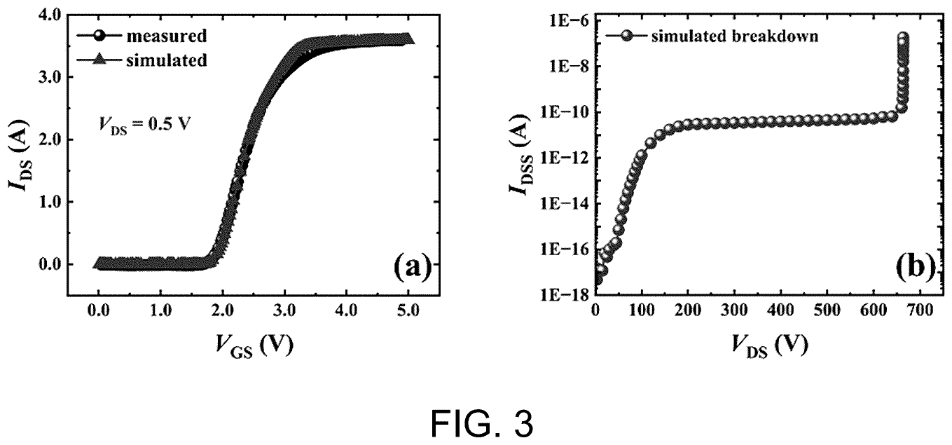

(2) Physical models and calculation methods are selected and the electrical characteristics of GaN devices are obtained; the selection of physical models includes mobility models, carrier statistical models, recombination models, polarization models, and the like; Newton's iterative method is chosen as the calculation method. Then, by adjusting the doping concentration and structural size parameters for the GaN device, the electrical characteristics of the GaN device is optimized to be consistent with the standard values in the GaN device manual. The electrical characteristic curve of the optimized GaN device is as illustrated in FIG. 3.

(3) Neutron irradiation simulation is performed on optimized GaN devices, and the trap information generated inside GaN devices is calculated during neutron irradiation by adding displacement damage related models. To ensure effective penetration of GaN devices by neutron irradiation, high-energy neutrons with energies higher than 1 MeV should be selected for irradiation; When the neutron irradiation energy is higher than 10 MeV, the non ionizing energy deposition is small, which can easily cause single event effects in GaN devices. The range of neutron irradiation energy E is between 1 MeV and 10 MeV to alleviate the leakage degradation of GaN devices. In one specific embodiment, neutron irradiation energy E=2.5 MeV is selected.

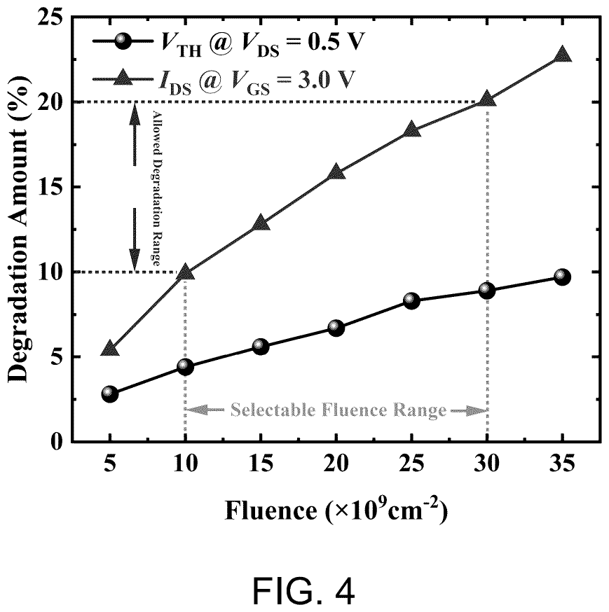

(4) The neutron irradiation fluence is varied, the electrical characteristic curves under different irradiation fluences are obtained, and the most sensitive electrical parameters are selected as the standard for evaluating the performance degradation of GaN devices after neutron irradiation. As illustrated in FIG. 4, the degradation of the main electrical characteristics of GaN devices after neutron irradiation is observed, and it is found that the degradation amplitude of the output saturated drain current I_{DS} is greater than that of the threshold voltage V_{TH}. Therefore, the output saturated drain current I_{DS} is selected as the standard for evaluating the electrical performance degradation of GaN devices.

(5) The variations in sensitive parameters under different irradiation fluences are compared, and the minimum neutron irradiation fluence F_{MIN} and the maximum neutron irradiation fluence F_{MAX} corresponding to the degradation values for the sensitive parameters are determined. The variations in sensitive parameters under different neutron irradiation fluences are compared, it is considered that when the degradation amplitude of the parameter exceeds 10%, sufficient traps are introduced into the GaN device. The irradiation fluence corresponding to the 10% degradation of the sensitive parameter is taken as the minimum fluence F_{MIN} to alleviate the leakage degradation effect of the GaN device; according to NASA's regulations in the “Instructions for EEE Parts Selection, Screening, Qualification, and Derating” (EEE-INST-002) document, for electronic components used in spacecraft, the degradation of most performance parameters can not exceed 20%. The neutron irradiation fluence at which sensitive parameters degrade by 20% is taken as the maximum fluence F_{MAX} to mitigate the leakage degradation effect of GaN devices.

In one specific embodiment, when the neutron irradiation fluence is between 1×10¹⁰ n/cm² and 3×10¹⁰ n/cm², the degradation range of the drain current I_{DS} is between 10% and 20%. Therefore, the minimum fluence F_{MIN} for the 2.5 MeV neutron irradiation test is 1×10¹⁰ n/cm², and the maximum fluence F_{MAX} is 3×10¹⁰ n/cm².

(6) Qualified GaN device samples are selected for electrical parameter testing and neutron irradiation tests are conducted on GaN devices; the neutron irradiation fluence is selected as one certain value between F_{MIN} and F_{MAX}. A single energy neutron irradiation with an energy of 2.5 MeV is conducted on the selected qualified GaN devices. The total neutron irradiation fluence is selected as 1.8×10¹⁰ n/cm², and the three terminal electrodes of the GaN device are suspended during neutron irradiation. The test environment temperature is room temperature, and the neutrons are vertically incident on the GaN device.

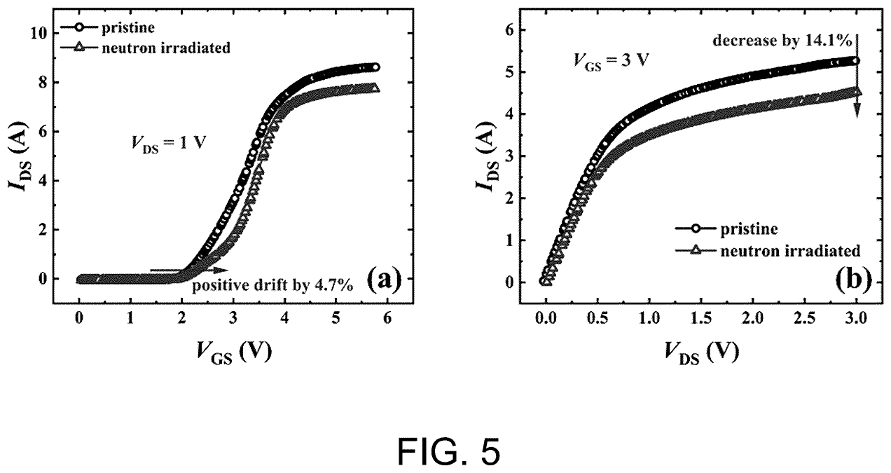

(7) Neutron irradiation is terminated when the neutron irradiation fluence reaches the preset fluence, and the anti leakage degradation performance of GaN devices is optimized; after the residual neutron irradiation fluence reaches the safe value, electrical performance are measured on the optimized GaN devices, the degradation values for electrical characteristics before and after neutron irradiation are compared to determine whether the degradation values satisfy the derating requirements, and the data are saved. Electrical performance measurement are conducted on GaN devices, and a comparison of the transfer characteristic curve and output characteristic curve of GaN devices before and after neutron irradiation is as illustrated in FIG. 5. It can be known from FIG. 5 that the output saturation drain current I_{DS} of GaN devices decreases by 14.1% after neutron irradiation, satisfying the maximum derating requirement in the GaN device industry standard.

(8) Irradiation are conducted on GaN devices treated with neutron irradiation, whether the anti leakage degradation performance of GaN devices is improved is verified. To verify the improvement of the anti leakage degradation ability of GaN devices after neutron irradiation, heavy-ion irradiation are conducted on GaN devices. The ion type is Ta ion, with the energy of 1332.16 MeV and an LET of 82.1 MeV·cm²/mg. The GaN device is in the off state during heavy-ion irradiation, and the test environment temperature is room temperature, with particles vertically incident on the surface of the GaN device.

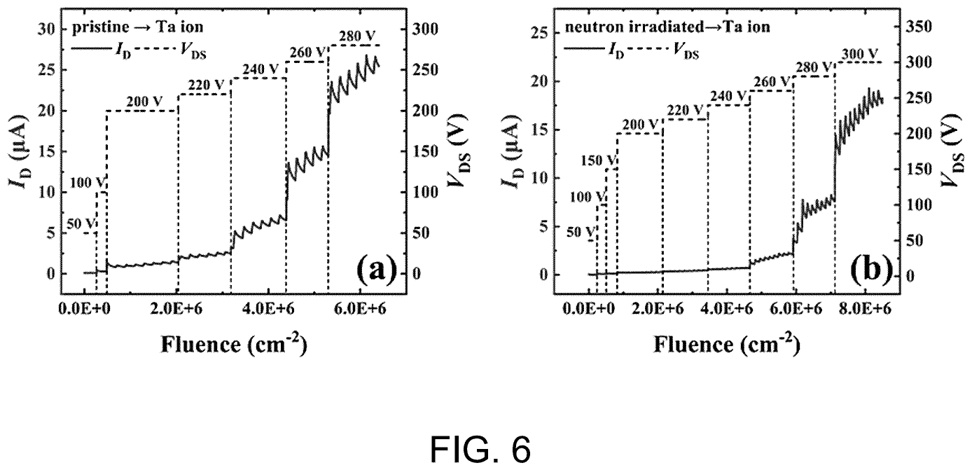

Non-irradiated GaN devices with good electrical performance are taken as the control group for heavy-ion irradiation tests. During the test, V_{DS} is slowly increased to cause leakage degradation of the GaN devices. The variation in leakage current I_{D} of the GaN devices is observed, and irradiation is terminated after V_{DS} reaches 280 V. (a) of FIG. 6 illustrates the original data chart of leakage degradation in GaN devices without neutron irradiation; as illustrated in (a) of FIG. 6, the leakage current I_{D} of GaN devices gradually increases with the increase of heavy-ion irradiation fluence. At 280 V, the final leakage current I_{D} is 25.5 μA, and the total irradiation fluence is 6.4×10⁶/cm².

GaN devices treated with 2.5 MeV neutron irradiation are taken as the experimental group for heavy-ion irradiation tests to observe the phenomenon of leakage degradation during heavy-ion irradiation. (b) of FIG. 6 illustrates the original data chart of leakage degradation in GaN devices after 2.5 MeV neutron irradiation; as illustrated in (b) of FIG. 6, the leakage current I_{D} of GaN devices gradually increases with the increase of irradiation fluence. At 300 V, the final leakage current I_{D} is 18.3 μA, and the total irradiation fluence is 8.5×10⁶/cm².

By analyzing and comparing the final leakage current I_{D} of the control group and the experimental group, it is found that the GaN devices after 2.5 MeV neutron irradiation have lower final leakage current I_{D} than those without neutron irradiation under conditions of more heavy-ion irradiation and greater drain voltage V_{DS}, which indicates that the anti leakage degradation ability of GaN devices treated with neutron irradiation is enhanced.

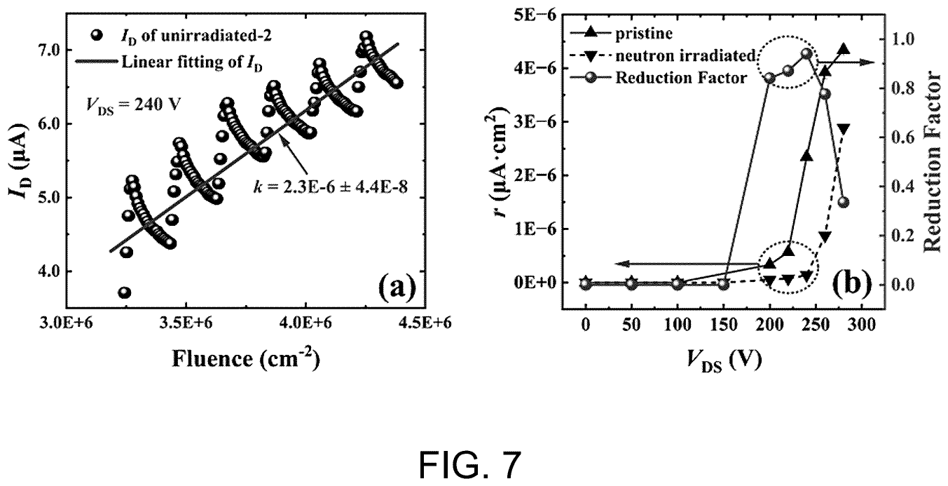

It is indicated according to the existing research that under the same V_{DS} conditions, the leakage current I_{D} of GaN devices during leakage degradation is linearly correlated with the irradiation fluence. The leakage current I_{D} under the same V_{DS} is linearly fitted with the irradiation fluence, and the slope of the fitted line is named as “leakage rate” r. The variation curve of the leakage rate r of GaN devices before and after neutron irradiation with V_{DS} is obtained (as illustrated in FIG. 7). It can be seen from (b) of FIG. 7 that after entering the leakage degradation zone, under the same V_{DS} conditions, the leakage rate r_{irradiated} of GaN devices subjected to neutron irradiation is reduced compared with the leakage rate rₚᵣᵢₛₜᵢₙₑ of non-irradiated GaN devices, and the leakage rate r_{irradiated} decreases by approximately 90% at V_{DS}=240 V, indicating that under the same neutron irradiation fluence, the leakage current I_{D} in GaN devices after neutron irradiation is smaller than that of non irradiated GaN devices, effectively alleviating the leakage degradation effect. In summary, the embodiments of the present disclosure demonstrate that 2.5 MeV neutron irradiation with a fluence of 1.8×10¹⁰ n/cm² can effectively alleviate the leakage degradation effect of p-GaN gate HEMT devices and improve the anti leakage degradation capability of GaN devices.

The present disclosure innovatively proposes a method for alleviating a leakage degradation effect of a GaN device, which not only avoids the modifications to the layout design and processing technique of the GaN device, but also does not require additional radiation-hardening circuits. Only by determining the suitable neutron irradiation conditions and conducting the neutron pre irradiation test on the GaN device, the anti leakage degradation performance of the GaN device can be improved. The method combines the simulation and the experimentation, systematically determine the neutron irradiation conditions suitable for optimizing the anti leakage degradation performance; the method is easy to operate, highly reliable, and effectively reduces the experimental costs through simulation, which not only improves the research and development efficiency, but also ensures the accuracy and reproducibility of experimental results, with good economic and technical advantages. The method pretreats the GaN devices through irradiation, which can optimize the anti leakage degradation performance of a large number of GaN devices simultaneously, without limiting the types of GaN devices, and has good convenience and universality. After the neutron irradiation treatment, the electrical performance of the GaN device in present disclosure deteriorates by no more than 20%, satisfying the maximum derating requirement in the industry standard, however, the anti leakage degradation ability of the GaN device is significantly improved. Even under a high LET heavy ion irradiation, the increase in leakage current is significantly reduced, fully demonstrating the superiority and effectiveness of this technology.

The above is the preferred embodiments of the present disclosure. It should be pointed out that for ordinary technical personnel in this field, a plurality of improvements and embellishments can be made without departing from the principles of the present disclosure, and these improvements and embellishments should also be considered as the protection scope of the present disclosure.

What is claimed is:

1. A method for alleviating a leakage degradation effect of a gallium nitride (GaN) device, comprising:
a step 1, selecting a type of a GaN device that is required to be optimized for an anti leakage degradation performance, and establishing, based on structural parameters for the selected GaN device, a two-dimensional structural model of the GaN device in a TCAD;
a step 2, selecting a physical model and a calculation method, obtaining electrical characteristics of the GaN device, and then optimizing, by adjusting a doping concentration and structural size parameters for the GaN device, the electrical characteristics of the GaN device to be consistent with a standard value in a GaN device manual;
a step 3, performing a neutron irradiation simulation on the optimized GaN device, and calculating, by adding a displacement damage related model, trap information generated inside the GaN device during the neutron irradiation;
a step 4, varying a neutron irradiation fluence, obtaining electrical characteristic curves under different irradiation fluences, and selecting a most sensitive electrical parameter as a standard for evaluating a performance degradation of the GaN device after the neutron irradiation;
a step 5, comparing variations in sensitive parameters under the different irradiation fluences, and determining a minimum neutron irradiation fluence F_{MIN} and a maximum neutron irradiation fluence F_{MAX} corresponding to degradation values for the sensitive parameters;
a step 6, selecting a qualified GaN device sample for an electrical parameter measurement, and conducting a neutron irradiation on the GaN device, wherein the neutron irradiation fluence is selected as one certain value between F_{MIN} and F_{MAX}; and
a step 7, terminating, when the neutron irradiation fluence reaches a preset fluence, the neutron irradiation, and completing optimizing the anti leakage degradation performance of the GaN device.

2. The method for alleviating the leakage degradation effect of the GaN device according to claim 1, wherein in the step 3, a range of a neutron irradiation energy E for alleviating the leakage degradation in the GaN device is between 1 MeV and 10 MeV.

3. The method for alleviating the leakage degradation effect of the GaN device according to claim 1, wherein in the step 5, the minimum neutron irradiation fluence F_{MIN} corresponds to a 10% degradation value for the sensitive parameters, and the maximum neutron irradiation fluence F_{MAX} corresponds to a 20% degradation value for the sensitive parameters.

4. The method for alleviating the leakage degradation effect of the GaN device according to claim 1, wherein after a residual neutron irradiation fluence reaches a safe value, an electrical performance measurement is performed on the optimized GaN device in the step 7, degradation values for the electrical characteristics before and after the neutron irradiation are compared to determine whether the degradation values satisfy derating requirements, and the data are saved.

5. The method for alleviating the leakage degradation effect of the GaN device according to claim 4, wherein an irradiation test is conducted on the GaN device treated with the neutron irradiation, whether the anti leakage degradation performance of the GaN device is improved is verified.
